(19) United States
(12) Patent Application Publication
(10) Pub. No.: US 2010/0100399 A1
(43) Pub. Date: Apr. 22, 2010

(54) SYSTEM AND METHOD FOR ADMINISTERING INSURANCE ACCOUNTS

(75) Inventors: Philip W. Michalowski, Glastonbury, CT (US); Keith E. Golembiewski, Suffield, CT (US); Joseph M. Weiss, Glastonbury, CT (US)

Correspondence Address: Howard IP Law Group, P.O. Box 226, Fort Washington, PA, 19034, US

(73) Assignee: HARTFORD FIRE INSURANCE COMPANY, Hartford, CT (US)

(21) Appl. No.: 12/254,215

(22) Filed: Oct. 20, 2008

(51) Int. Cl. G06Q 40/00; G06Q 30/00

(52) U.S. Cl. 705/4; 705/35; 705/40; 705/45; 705/14.49

(57) ABSTRACT

A computer system for administering an insurance account includes a processor and a memory in communication with the processor. The processor is adapted to: access from a memory storage device data indicative of a payment mode associated with premium payments to the account or payments from the account; access from the memory data indicative of a calculation associated with the account dependent on the payment mode; perform the calculation based on the accessed payment mode dependent data; and provide an output signal having data indicative of the performed calculation.

### FIELD OF INVENTION

The present invention relates to computer systems, and particularly to computer systems for calculating features of financial products.

### BACKGROUND

An annuity is a type of insurance service. In general terms, in an annuity contract, an insurance company and an annuitant contract for the annuitant to make one or more premium payments to the insurance company. For that consideration, the insurance company makes periodic payments to an annuitant. By way of example, the insurance company may be obliged to make a payment of a predetermined amount to the annuitant annually for a predetermined time period. In another example, the insurance company is obliged to make payments of a predetermined amount to the annuitant annually for the life of the annuitant. Payments may be made by check or by electronic funds transfer to an account designated by the annuitant, such as a bank account designated by the annuitant.

### SUMMARY OF THE INVENTION

In one embodiment, a computer system for administering a variable annuity account has a processor and a memory in communication with the processor. The processor is adapted to: access from a memory storage device data relating to the variable annuity account; access from the memory storage device data indicative of a payment mode associated with premium payments to or withdrawal payments from the variable annuity account; access from the memory storage device data indicative of a factor in a formula associated with the account, a value of the factor being dependent on the payment mode; perform, based at least in part on the accessed factor value, one or more calculations associated with the insurance account; and provide an output signal comprising data indicative of a result of the one or more calculations.

In an embodiment, a computer system for administering an insurance account includes a processor and a memory in communication with the processor. The processor is adapted to: access from a memory storage device data relating to the insurance account; access from the memory data indicative of a payment mode associated with premium payments to the account or payments from the account; access from the memory data indicative of a calculation associated with the account dependent on the payment mode; perform the calculation based on the accessed payment mode dependent data; and provide an output signal including data indicative of the performed calculation.

In an embodiment, a computer-implemented method for administering an insurance account includes accessing by a processor from a memory storage device in communication with the processor data indicative of a payment mode associated with premium payments to the account or payments from the account; accessing by the processor from the memory storage device data indicative of a calculation associated with the account dependent on the payment mode; performing by the processor the calculation based on the accessed payment mode dependent data; and providing by the processor an output signal comprising data indicative of a result of the performed calculation.

In an embodiment, a computer-readable medium has instructions thereon which, when executed by a processor, cause the processor to access from a memory storage device in communication with the processor data indicative of a payment mode associated with one or more premium payments to an insurance annuity account or one or more annuity or death benefit payments from the account; if the payment mode is associated with the one or more premium payments, access from the memory storage device data indicative of a calculation of at least one of a rider fee or a mortality and expense charge associated with the annuity account dependent on the payment mode, wherein a first premium payment mode pertains to premium payments from a designated account, and a second premium payment mode pertains to premium payments from all other sources, wherein the rider fee or mortality and expense charge is lower for the first premium payment mode than the second premium payment mode; if the payment mode is associated with one or more annuity or death benefit payments, access from the memory storage device data indicative of a calculation of the amount of the annuity or death benefit payment dependent on the payment mode, wherein a first outbound payment mode is to a debit card, gift card or insurance provider-designated account, and a second outbound payment mode is by check or electronic transfer to an account other than the designated account, a payment amount being larger if associated with the first outbound payment mode than the second outbound payment mode; perform the calculation based on the accessed payment mode dependent data; provide an output signal comprising data indicative of a result of the performed calculation.

### BRIEF DESCRIPTION OF DRAWINGS

FIG. 1 is a schematic diagram of an exemplary computer system for implementation of a method and system of the invention.

FIG. 2 is a schematic diagram of an exemplary network for implementation of a method and system of the invention.

FIG. 3 is a process flow diagram illustrating a method for administering annuities having payment amounts dependent on payment modes and implemented by the computer system of FIG. 1.

FIG. 4 is a schematic diagram illustrating elements in a system and method of the invention.

FIG. 5 is a schematic diagram illustrating an exemplary network of implementation of a method and system of the invention.

FIG. 6 is a schematic diagram illustrating exemplary computer systems involved in implementation of a method and system of the invention.

FIG. 7 is a table illustrating exemplary annuities in accordance with an embodiment of the invention.

FIG. 8A is a table illustrating an exemplary prior art annuity and FIG. 8B is a table showing an exemplary annuity having payment augmentation in accordance with an embodiment of the invention.

FIG. 9A is a table illustrating an exemplary prior art annuity and FIG. 9B is a table showing an exemplary annuity having a reduced rider fee in accordance with an embodiment of the invention.

FIG. 10A is a table showing an exemplary prior art annuity and FIG. 10B is a table showing an exemplary annuity having a reduced rider fee in accordance with an embodiment of the invention.

FIG. 11 is a process flow diagram illustrating a method of administering an insurance account in accordance with an embodiment of the invention.

FIG. 12 is a process flow diagram illustrating a method of administering an insurance account having rider fees dependent on payment mode data in accordance with an embodiment of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems, and methods for administration of insurance accounts and insurance products such as annuities. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

A challenge recognized by the inventors is that, following a payment by an insurance provider to an annuitant, for example, there is no relationship between the annuitant and the insurance provider relative to that payment. There is no incentive for the annuitant to continue to do business with the insurance provider relative to that payment. The insurance provider loses use of the funds, even if the annuitant merely deposits the funds with a bank, rather than spending the funds immediately.

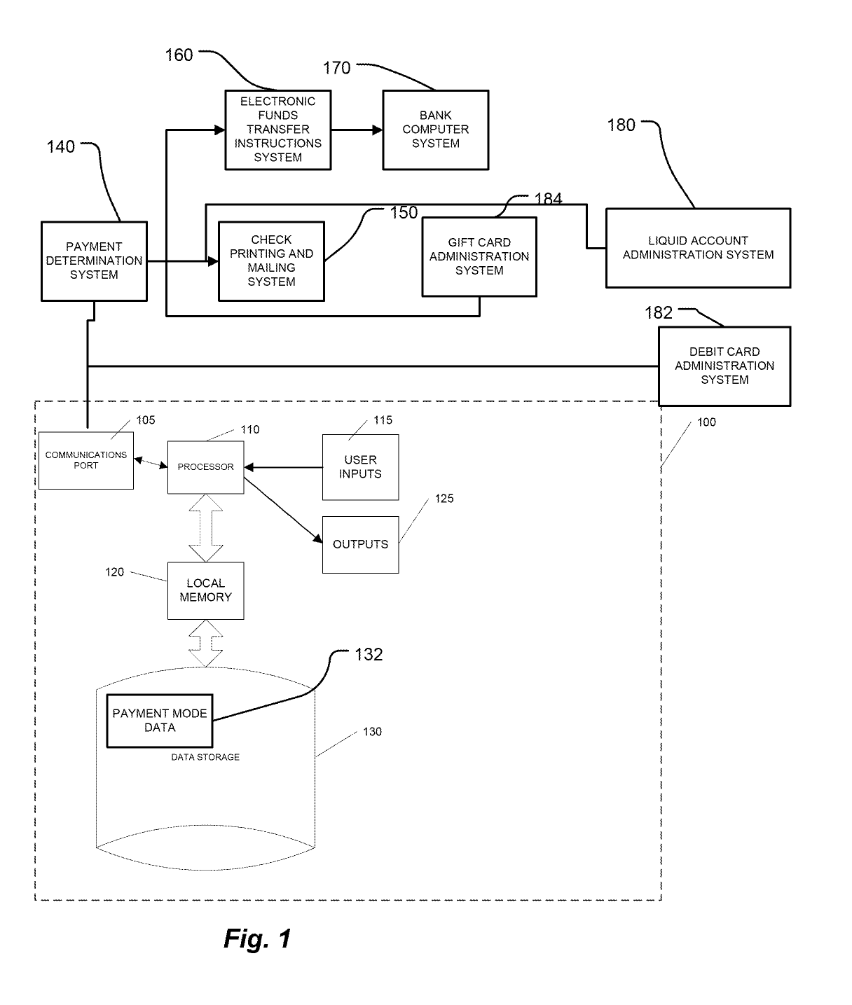

Referring to FIG. 1, an exemplary computer system 100 for use in an implementation of the invention will now be described. In computer system 100, processor 110 executes instructions contained in programs stored on stored media. Processor 110 communicates, such as through suitable buses and other data channels, with communications port 105 and local memory 110, receives data from user inputs 115, and provides data to outputs 125. Local memory 120 is configured to exchange data with processor 110, and may store programs containing processor-executable instructions, and values of variables for use by such programs. Data storage 130 may include a wide variety of data acquired and processed in accordance with the invention. Data storage 130 may include payment mode data 132, by way of example. User input may be provided at inputs 115, which may include keyboards, pointing devices such as mice, and touchscreens. In an embodiment, inputs 115 may include user interfaces, including workstations having keyboards, touchscreens, pointing devices such as mice, or other user input devices, connected via networked communications to processor 110. Outputs 125 may include displays and printers. Communications port 105 may communicate with remote sources of information, and with systems for implementing instructions output by processor 110. Communication may be by one or more of suitable communication methods, including over wired or wireless local area networks and wide area networks, and over communications between networks, including over the Internet. Any suitable data and communication protocols may be employed.

Communications port 105 may communicate with payment determination system 140. Payment determination system 140 may include one or more computer systems, including processors, memory devices, user inputs, outputs, software executed by the processors, and other conventional components. Payment determination system 140 may be adapted to receive an output signal via communications port 105, which output signal includes data indicative of payment information, such as an amount, a date payable, information identifying an annuitant, and a payment mode. Payment determination system 140 may further be adapted to determine a payor account and a payment method. The payor account may be an account with a selected bank; by way of example, payment determination system 140 may include a look-up table mapping annuitant information, such as geographic information, to a particular bank and account. Payment determination system 140 may also include stored in memory and accessible by a processor information indicating whether a particular annuitant is to be paid by paper check, by electronic funds transfer, or by another payment mode, or in some other manner. A processor of payment determination system 140 may cause to be stored in memory of the payment determination system the determined payor account information and the determined payment method. The processor of payment determination system 140 may cause a digital signal to be output indicative of the stored payor account information, the stored payment method, amount information and payee information. Depending on the payment method or mode information, payment determination system 140 may direct a signal to one of a number of potential recipients. The potential recipients may include payment fulfillment systems, such as check printing and mailing system 150 and electronic funds transfer instructions system 160. The payment fulfillment systems may be for receiving the digital signal from the payment determination system 140 and for fulfillment of payment in accordance with the information conveyed by the digital signal from the processor of the payment determination system 140.

In an embodiment, the payment mode may be a cash payment, and the payment method may be by check; given that payment method, the output digital signal from payment determination system 140 may be received by check printing and mailing system 150. Check printing and mailing system 150 may include one or more computer systems, including processors, memory devices, user inputs, outputs, software executed by the processors, and other conventional components. The outputs include in particular one or more printers, and may include other devices useful in printing and mailing paper checks, such as devices for feeding paper, separating printed checks, inserting printed checks into envelopes, sealing envelopes, and applying postage to envelopes as appropriate. Check printing and mailing system 150 may print a check drawn on a payor account in an amount and to a payee as determined by the information conveyed by the digital signal from the processor of payment determination system 140. The printed check is then mailed to the payee, which may be the annuitant. The annuitant deposits the check in the annuitant's bank account, causing funds to be credited to the annuitant's bank account, and causing the funds to be withdrawn from the designated payor bank account from which the payment is made.

In an embodiment, the output digital signal from payment determination system 140 may be received by electronic funds transfer instructions system 160. For example, this may be the case if the payment mode is cash and the payment method is by electronic funds transfer to the annuitant's designated account. Electronic funds transfer instructions system 160 may include one or more computer systems, including processors, memory devices, user inputs, outputs, software executed by the processors, and other conventional components. Electronic funds transfer instructions system 160 includes a processor adapted to provide an output signal indicative of an instruction to a bank determined by the payor account information to provide an electronic funds transfer from the payor account to a payee account in an amount as previously determined, such as by processor 110. The amount is the amount determined by the information conveyed by the digital signal from payment determination system 140.

The output signal from electronic funds transfer instructions system 160 may be provided to a bank computer system 170, which carries out an electronic funds transfer, debiting the designated account, and resulting in a credit to a designated annuitant account.

If the payment mode is of a type other than a cash payment to the annuitant, then the output digital signal from the payment determination system 140 may be directed to a fulfillment system such as one of gift card administration system 184, liquid account administration system 180 and debit card administration system 182. In an embodiment, the payment mode may be for payment to a liquid account administered by the provider of the annuity. A liquid account administration system maintained by the entity that administers the annuity account may receive the output digital signal. In response to receipt of the output digital signal, a processor of the liquid account administration system may cause to be recorded in memory a credit to an account balance in an amount indicated by data in the output digital signal. In an embodiment, the payment mode may be for issuance of a debit card; the output digital signal from the payment determination system 140 may be received by a debit card administration system 182. In response to receipt of the output digital signal, a processor of the debit card administration system 182 may cause a signal to be provided containing data indicative of an instruction to provide a debit card to the annuitant having a balance equal to a payment amount indicated by the output digital signal from the payment determination system. The debit card administration system may be provided by a third party, and an account of the insurance provider may be debited in the amount of the debit card, for example. A debit card may be generated and provided to the annuitant, such as by postal mail, and an account associated with the debit card created in memory of the debit card administration system.

In an embodiment, the payment mode may be for a gift card. The output digital signal from the payment determination system 140 may be directed to gift card administration system 184. In response to receipt of the digital output signal from the payment determination system 140, a processor of the gift card administration system may provide one or more output signals to cause a gift card and corresponding account to be generated in the name of the annuitant and in an amount indicated by the data included in the output digital signal from the payment determination system 140. In an embodiment, the gift card may be available to be redeemed for purchases at one and only one retailer, or at more than one retailer.

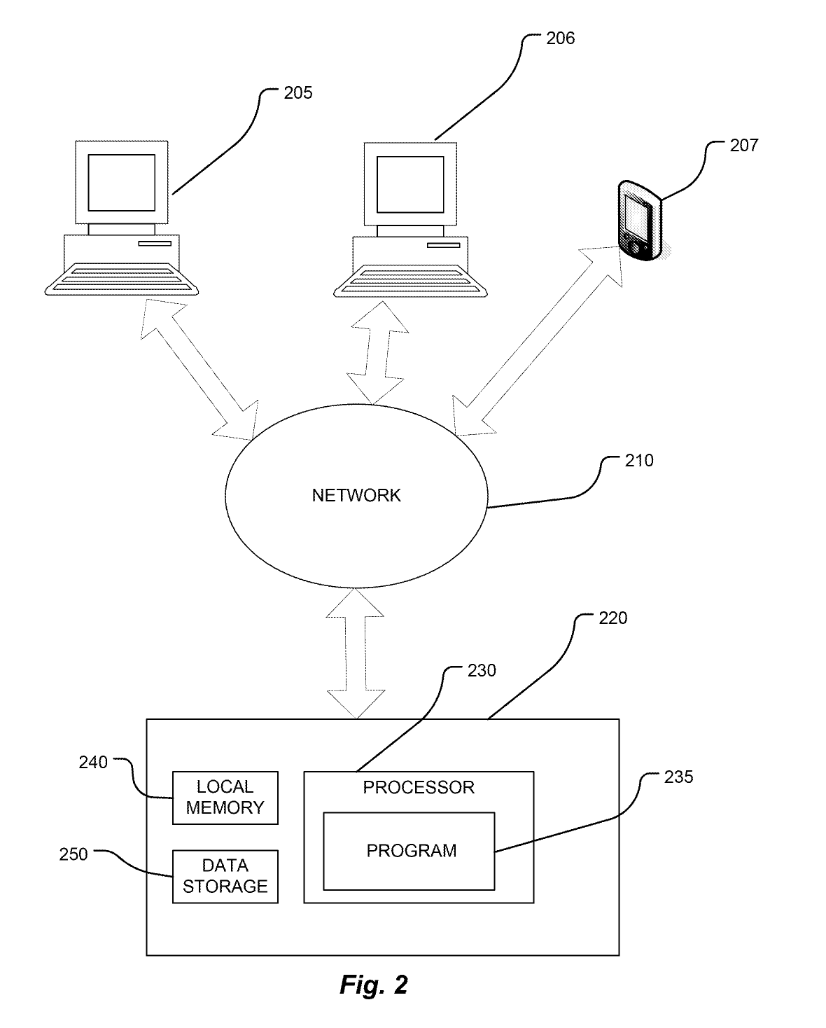

Referring now to FIG. 2, a schematic diagram of a client server arrangement for implementation of a method and system in accordance with an embodiment of the invention is presented. In the arrangement of FIG. 2, client devices 205, 206, 207 may be connected via network 210 to server 220. In an implementation, client devices 205, 206, 207 may be personal computers running an operating system such as Windows XP, Windows Vista, or Apple Tiger, thin client devices, portable devices such as personal digital assistants (running the Palm OS, by way of example), cell phones, or other devices. Client devices may be operated variously by individual prospective annuitants, insurance brokers or other financial advisors, or by personnel of an insurance service provider. Network 210 may be or include the Internet, a corporate intranet, wireless and wired communications channels, and other network features. Server 220 may include processor 230 having local memory 240 and data storage 250. Program 235 runs on processor 230. Program 235 may initiate sessions with one more of client devices 205, 206, 207. Program 235 may cause server 220 to serve for display on client devices 205, 206, 207, prompts to the user for information regarding available assets, desired income and desired asset value goals, and/or possible expense items, and based on information received and various algorithms related to annuity contracts, provide examples for annuity contracts and various payment modes, such as liquid accounts, debit cards and gift cards. Program 235 may also provide a web front end, and be linked to back end computer systems for implementing administration of annuities, as well as to back end systems for other insurance company-administered products and services, such as a liquid account. Program 235 may, by way of example, provide a user a menu of payment modes, and be configured to receive a signal from user device 205, 206, 207 selecting a payment mode, and to communicate a mode selection to a back end system, such as system 100, so as to permit user selection of a payment mode. Program 235 may be, by way of example only, a Java-based program.

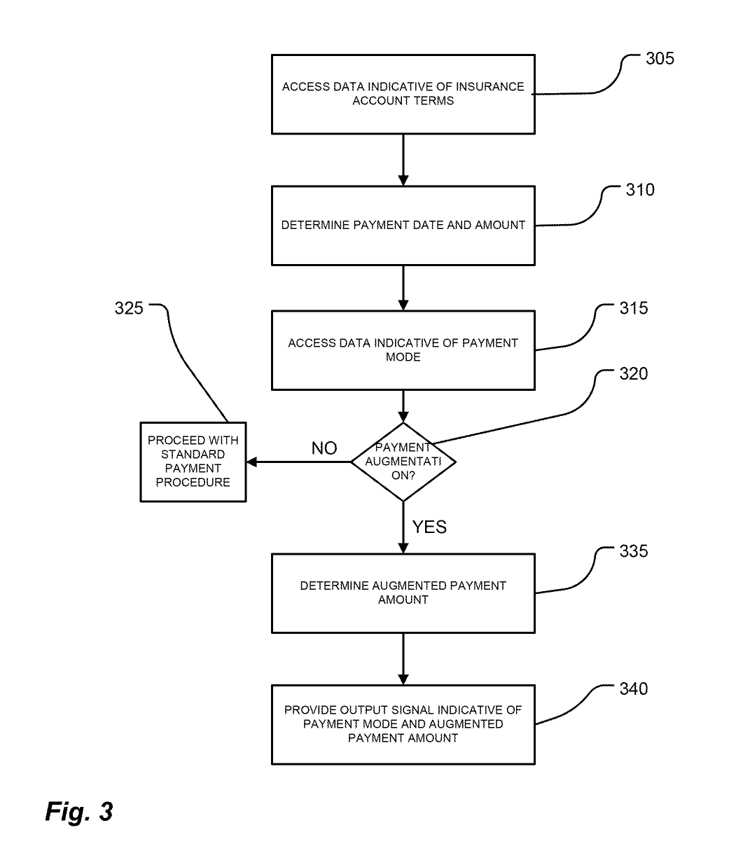

Referring now to FIG. 3, a high level process flow of a method for administering an insurance account will be explained, with reference to the computer system of FIG. 1. In accordance with an implementation, an insurance company and a customer have entered into an insurance contract. Examples of insurance products covered by such a contract include annuities, such as single premium immediate annuities, variable annuities, and variable annuities with lifetime guaranteed minimum withdrawal benefits; investment funds such as mutual funds; special purpose investment accounts, such as education savings accounts and retirement savings accounts, and other accounts.

In an implementation, a processor, such as processor 110 of FIG. 1, may access data indicative of insurance account terms 305. By way of example, terms may be stored in a memory, such as data storage 130 of FIG. 1. Terms may include, by way of example, for an annuity, funding amounts and dates, annuitant identity information, and other information reflecting annuity terms. The process flow then proceeds to determining a payment date and amount 310. Payment date and amount may be calculated by a processor based on accessed insurance account terms. Alternatively, payment date and amount may be determined by accessing in a memory. For example, in a single premium immediate annuity, the payment dates and amounts may be predetermined and stored in a memory storage device.

The process flow then proceeds to accessing date indicative of a payment mode 315. Payment mode information 315 may be stored in memory. In an example, payment mode information may indicate that payment is to be in the form of a cash payment. In an example, payment mode information may indicate that payment is to be made by crediting an account administered by the insurance provider. The credited account may be a liquid account, such as a money market account, for example. The funds in the account may be immediately available to the annuitant at the annuitant's option, thereby rendering the account a liquid account. The payment mode may be in the form of a gift card, such as a gift card of a designated retailer. The payment mode may be debit card, such as a debit card provided through a credit card processor.

The payment mode may apply to an entire payment, or to a designated portion of a payment. For example, a first portion of a payment, which may be a percentage of a payment or a dollar amount, may be designated for gift card payment mode, while the remainder of the payment may be designated for cash payment mode. A payment augmentation is applicable to the first portion, and not to the second portion. An augmented payment is provided as to the first portion. In an embodiment, a processor may be adapted to access data indicative of a first payment mode associated with the first portion of a payment from the insurance account, and a second payment mode associated with a second portion of the payment, and determine an amount of an augmented payment based on the first portion of the payment and the payment augmentation data.

In an implementation, the insurance contract may provide for payment augmentation based on a selected payment mode. By way of example, an additional percentage amount, such as 2 percent or 5 percent or 8 percent, may be provided for in a contract, for a selected payment mode, as compared to a cash payment. A memory location may include a flag indicating whether or not payment augmentation is provided for a particular payment mode. The augmentation formula or amount, consistent with contractual terms, may be stored in a memory location. If the processor checks the flag 320 and determines that there is no payment augmentation, then a standard payment procedure may proceed 325. The standard payment procedure may be in the standard amount, and may be a cash amount, as described above with reference to FIG. 1. If the processor checks the flag 320 and determines that there is payment augmentation, then the processor may proceed to determining an augmented payment amount 335. The determination may include accessing a formula based on the amount of the payment, and calculating the payment amount. The payment amount may be stored in local memory after calculation.

Further examples of payment augmentations may include adjustments to insurance products. By way of example, a payment augmentation may include: a reduction in a premium amount for an insurance product, an increase in a net asset value of an annuity; an increase in a death benefit for an insurance product; a waiver or an additional option under a contract. In an example, if the payee agrees to receive one or more payments in a payment mode of crediting a liquid account, the premium amount for an insurance product on which payments are made by the payee may be reduced in accordance with a formula. The formula for the amount of the premium reduction may be based on a percentage of the amount credited to the liquid account for example.

A formula for an amount of a payment augmentation may include a variety of factors. In an example, a factor may be a length of time that a payee has had insurance products with the payor insurance company. In general terms, as the length of time increases, the amount of payment augmentation increases.

The process flow then proceeds to providing a digital output signal including data indicative of the payment mode and the determined augmented payment amount 340. As described above in connection with FIG. 1, the digital output signal may be provided to a payment determination system. It will also be appreciated that the digital output signal may be provided to a printer for printing a report or statement that is provided to the annuitant or other user.

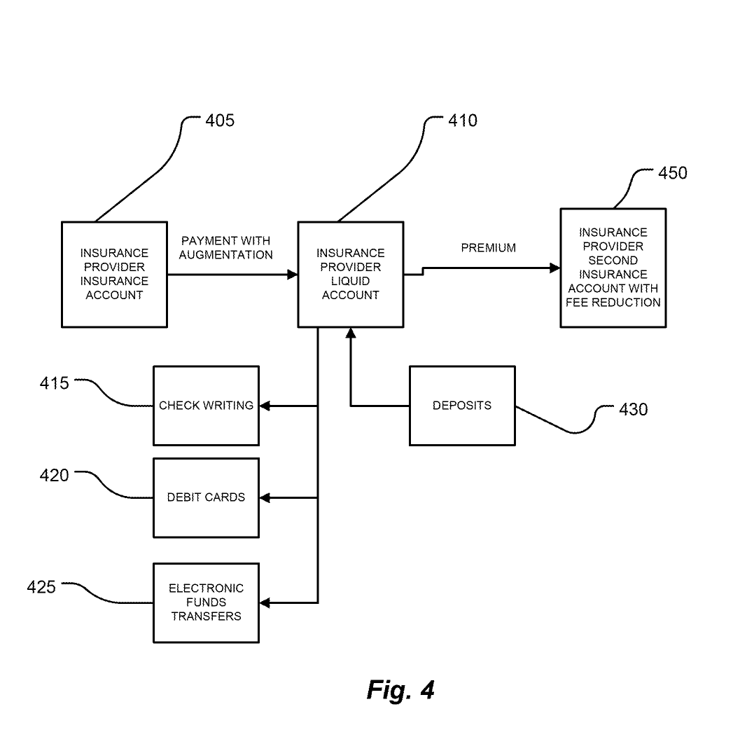

Referring now to FIG. 4, a schematic illustration of an implementation of a method and system of the invention is provided. Insurance provider insurance account 405 is shown. As discussed above, a payment mode of payment to an insurance provider liquid account 410, such as a money market account, may be provided. Payments to the liquid account 410 may include payment augmentation. Any suitable mechanism may be made available for making payments from the insurance provider liquid account. Examples include making electronic or paper checks available 415, providing a debit card 420, and making electronic funds transfers 425 available. In an implementation, the liquid account may be credited for use of the one of these modes of payment. By way of example, use of the debit card may be recorded in memory, and a processor may credit the liquid account 410 based on use of the debit card. By way of example, a credit of 0.1 percent to the account may be provided for use of the debit card. Bill payments may be provided by electronic funds transfer or generating electronic checks, for example. Mechanisms may also be provided for deposits 430 from sources other than payments from the insurance company account, such as permitting deposits from other accounts, such as bank checking accounts, by check, directing payments of dividends or other amounts from other investment accounts by automated transfer, or electronic transfers. Funds may also be removed from the liquid account and paid, as premiums by way of example, into insurance provider second account 450. For example, an insurance provider second account 450 may be an investment account or another annuity account. By way of example, an annuitant may choose to fund an account (such as a Section 529 account) for the education of a child or grandchild. By way of example, the insurance provider second account 450 may have reduced fees based on premiums being received from insurance provider liquid account 410.

In an embodiment, a method and system may be provided in which demographic information related to a beneficiary or an annuitant may be accessed and employed in calculation of an augmented or otherwise changed payment amount. In example, an insurance company database may already have demographic information, such as age, address, number and ages of children, marital status and age of spouse. In such an embodiment, a processor may access the stored demographic information, and, based on the stored demographic information, prompt the user for one or more different payment mode options. By way of example, if the database shows that a beneficiary under a death benefit of the annuity, or an annuitant, is an adult and lives at an address in a neighborhood of single family homes, then the system may prompt the user to select a payment mode under which a portion of the of the death benefit or annuity payment is paid as a premium to the same insurance company as a premium for homeowners insurance, automobile insurance, or another property/casualty insurance product. In another example, demographic data may show that an annuitant is in his or her prime earning years and living at an address in an affluent suburb. In that example, the system may prompt the user to select a payment mode in the form of a contribution to an insurance product, such as an annuity, providing deferred benefits to provide income during retirement. By way of example, a user may be prompted via a web page served to a user's client device. Upon receipt of the user payment mode selection, the processor may proceed to calculation of a

In another example, the demographic data may not be available in the insurance company memory storage device. In this embodiment, a user may be prompted for demographic information. For example, an insurance company may not have age information available for a beneficiary under a death benefit provision of an annuity. A processor may cause the user to be prompted for age and/or other demographic information, such as via a web page served by a server to a user device. Upon receiving the requested information in response to the prompt, a processor may cause the user to be prompted to select an option related to a payment mode.

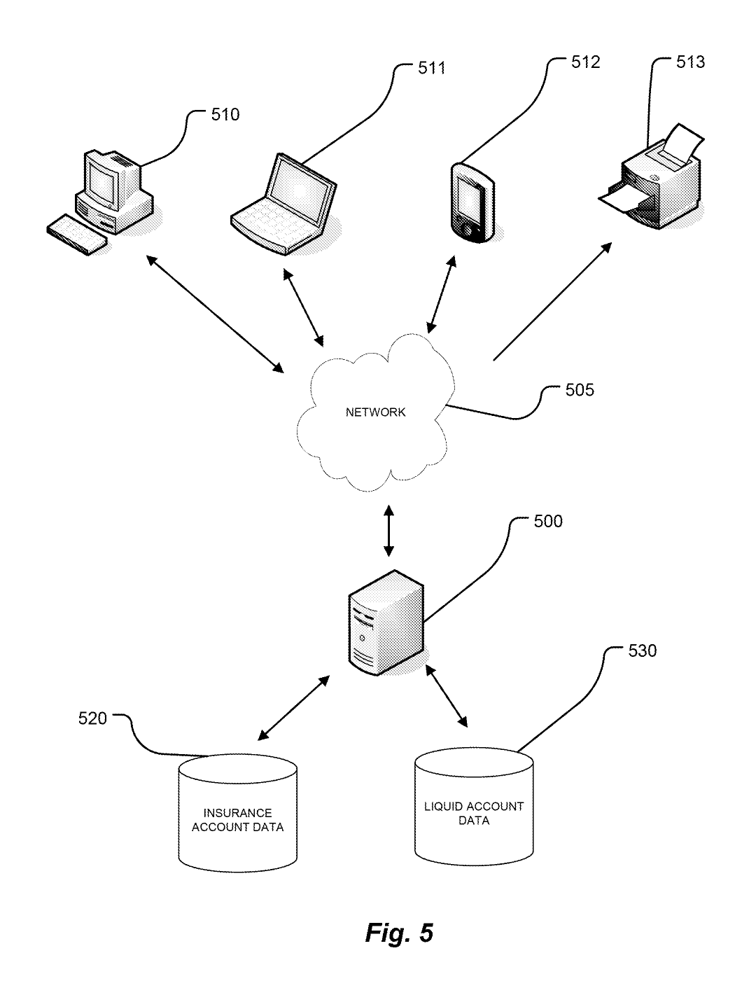

Referring now to FIG. 5, a system is illustrated in which a user may access both insurance account information, such as information concerning insurance account terms, annuity net asset values, schedules for payments, investment selections for variable annuities, and other information, and information concerning a liquid account, employing a single authentication process. Server 500, which may be a web server, for example, communicates via network 505, which may be the Internet, with client devices such as desktop computer 510, laptop 511, personal digital assistant 512, and printer 513. A user from computer 510, laptop 511 or PDA 512 may be authenticated, such as through a user name and password, through a digital key, or other authentication technique. Once server 500 has authenticated the user, then the processor of the server may access insurance account data from data storage 520 pertaining to any insurance accounts associated with the user, and liquid account data from data storage 530 pertaining to any liquid account of the user. Once the server processor accesses the information, it may be formatted and served for display on the authenticated client device. In an implementation, reports and other documents may be provided to a designated printer 513, such as a printer in the office of a financial advisor.

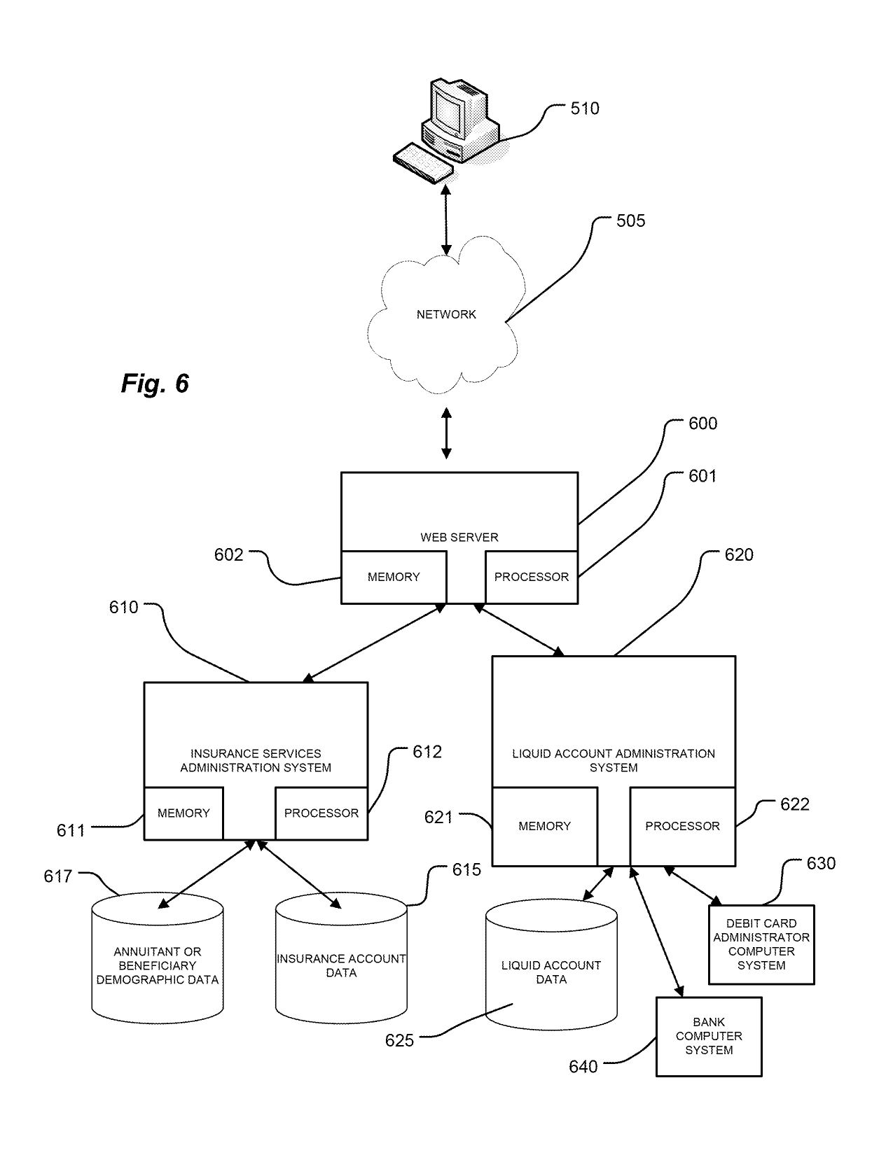

Referring now to FIG. 6, a system is illustrated in which a user may, from a client device and through a single authentication at a front end server, both view information and provide instructions relating to insurance accounts and liquid accounts administered by an insurance provider. In FIG. 6, web server 600 communicates via network 500, which may be the Internet, with client device 510. A user from client device 510 is authenticated, by any suitable method, including user name and password, keys, and other techniques, by processor 601 using programs stored in memory 602. When processor 601 has authenticated the user, processor 601 may access suitable tables, stored, for example, in memory 602 to correlate the authenticated user with user identities in the insurance services administration system 610 and the liquid account administration system 620. Processor 601 may then furnish a request to processor 612 to access and retrieve insurance data from insurance account data storage 615, and furnish a request to processor 622 to access and retrieve data from liquid account data storage 625. Processor 601 may also furnish a request to processor 612 to access and retrieve demographic data from annuitant or beneficiary demographic data storage 617. Demographic data storage may include information regarding an annuity owner, an annuitant, a beneficiary, or another. Demographic data storage may include information such as age, gender, age of spouse, ages of children, occupation, assets, address, and other information.

When data is returned by processor 612, after temporary storage in memory 611, and by processor 622, after temporary storage in memory 621, to web server 600, processor 601 causes the data to be formatted and transmitted, e.g., via TCP/IP, to client device 510 for display. Based on an algorithm and retrieved demographic data, a display may include options such as selecting an insurance product, such as homeowners insurance, for application of an annuity or death benefit payment. The display may include menus providing various functions, such as selecting a payment mode for a payment from an insurance account, selecting a portion of a payment, providing responses to demographic questions, such as age, address, and ages of children, and other options. The user may select appropriate commands, resulting in a signal from client device 510 to web server 600. Processor 601 then provides appropriate data to insurance services administration system 610 to designate payment modes, for example, or to generate appropriate forms of property/casualty insurance contract, by way of further example.

The display provided at client device 510 may also include options for instructions related to the liquid account, such as authorizing a debit card purchase, or authorizing an electronic transfer to a bank account for a bill payment. Suitable instructions are provided to web server 600. Processor 601 may transmit suitable instructions to processor 622, which provides a suitable digital output signal to a debit card administrator computer system 630 to generate a debit card and account, while suitably updating the data in liquid account data storage 625 to reflect debiting of the account. Similarly, if a transfer is authorized, processor 622 may generate a suitable digital output signal to a bank computer system 640.

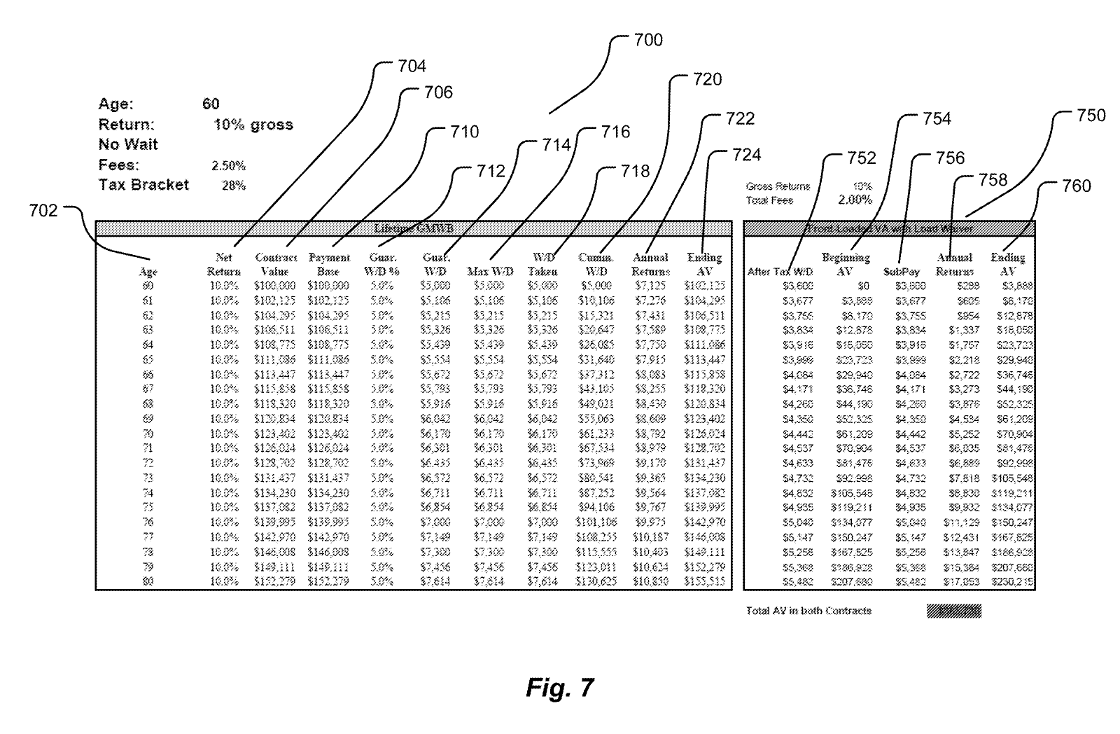

Referring now to FIG. 7, an illustration is provided of a method in which a life insurance benefit is obtained at reduced or no cost as a result of payment augmentation. In an example, payments from a life insurance account, such as an annuity having a guaranteed minimum withdrawal benefit, are directed to a designated liquid account. The annuitant and the insurance company enter into another insurance contract in the form of a variable annuity contract. The annuitant agrees to pay the after tax proceeds of the annuity having a guaranteed minimum withdrawal benefit as premiums in the variable annuity contract. The insurance company agrees to an additional benefit associated with the another insurance contract. In the illustrated embodiment, the another insurance contract is a variable annuity, and the additional benefit is in the form of the insurance company charging fees on the variable annuity less than the customary fees. In this example, the customary fees on the variable annuity contract are 2.5% of net asset value per year, and the fee charged is 2.0% of the net asset value annually. Referring to FIG. 7, chart 700 shows an illustrative insurance product, particularly an annuity, purchased by the annuitant at age 60, showing performance through age 80, as indicated by the age column at 702. In this illustration, an annual net return of 10.0% is assumed, as indicated at column 704. In this illustration, an initial asset value of $100,000 is assumed, as indicated at 706. The contract value for each succeeding year is taken from the asset value for the previous year from the ending asset value column 724. In this example, the entire asset value is the base for the guaranteed minimum withdrawal amount, so the payment base column 710 is always equal to the beginning asset value shown in column 706. The guaranteed minimum withdrawal percentage, which is set by contract, is 5.0% of the payment base, as indicated by column 712. The guaranteed minimum withdrawal amount, shown in column 714, is determined by calculating 5.0% of the payment base amount from column 710. In this example, the maximum withdrawal amount, indicated in column 716, is the same as the guaranteed minimum withdrawal amount. The actual withdrawal amount taken, shown in column 718, is also the same as the guaranteed minimal withdrawal. Column 720 shows the cumulative withdrawals from the inception of the account. Column 722 shows the annual return in dollars, based on the net return less fees on a balance determined by subtracting the actual withdrawal amount taken from the contract value. Column 724 shows the asset value at the end of the year, determined by adding to the contract value from column 706 the annual returns from column 722, and subtracting the actual withdrawal amount taken from column 718.

In a method according to an embodiment, the annuitant under the contract depicted in table 700 has a variable annuity contract funded from a liquid account. Table 750 depicts an illustrative variable annuity contract in which the entire after-tax balance of the withdrawals from the insurance contract depicted in table 700 are applied as premiums. An effective tax rate of 28% on the withdrawal amount is assumed, resulting in the after tax withdrawal amounts shown in column 752, which are the amounts of premiums paid in the variable annuity contract of table 750. The initial asset value for each year in the variable annuity contract is shown at column 754. The premium paid each year, which is the same as the after tax withdrawal amount, is shown in column 756. The annual returns, which are the rate of return, in this case 10%, less the reduced fee, in this case 2%, applied to the sum of the initial asset value and the premium paid, are shown in column 758.

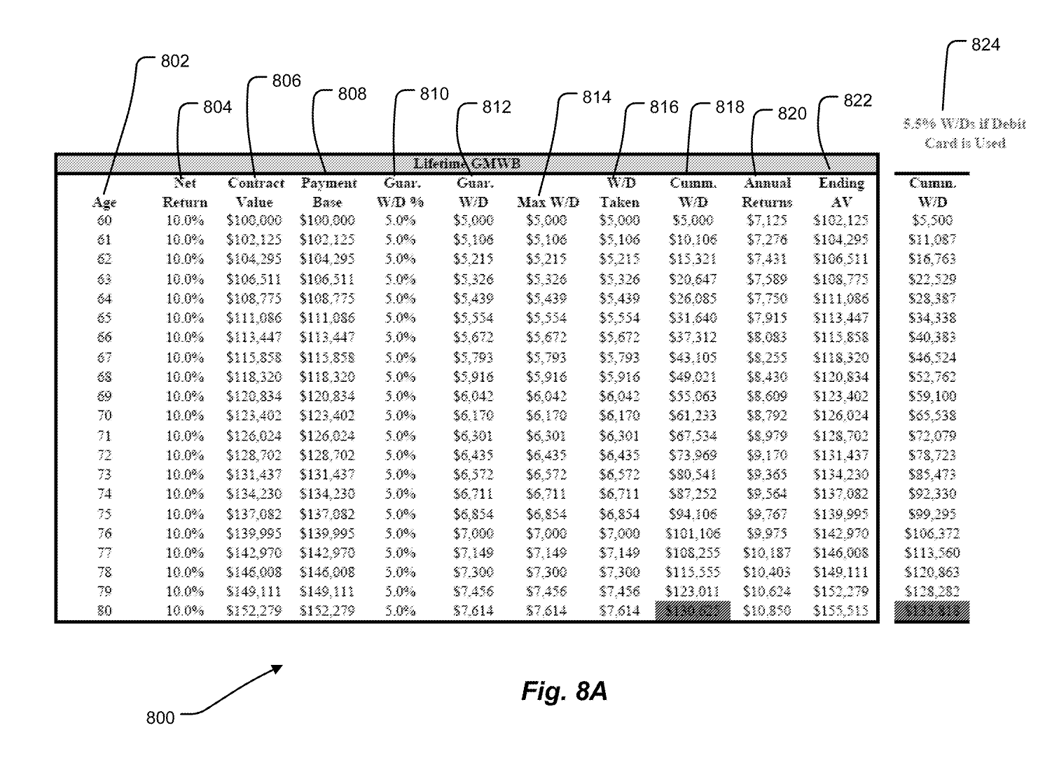

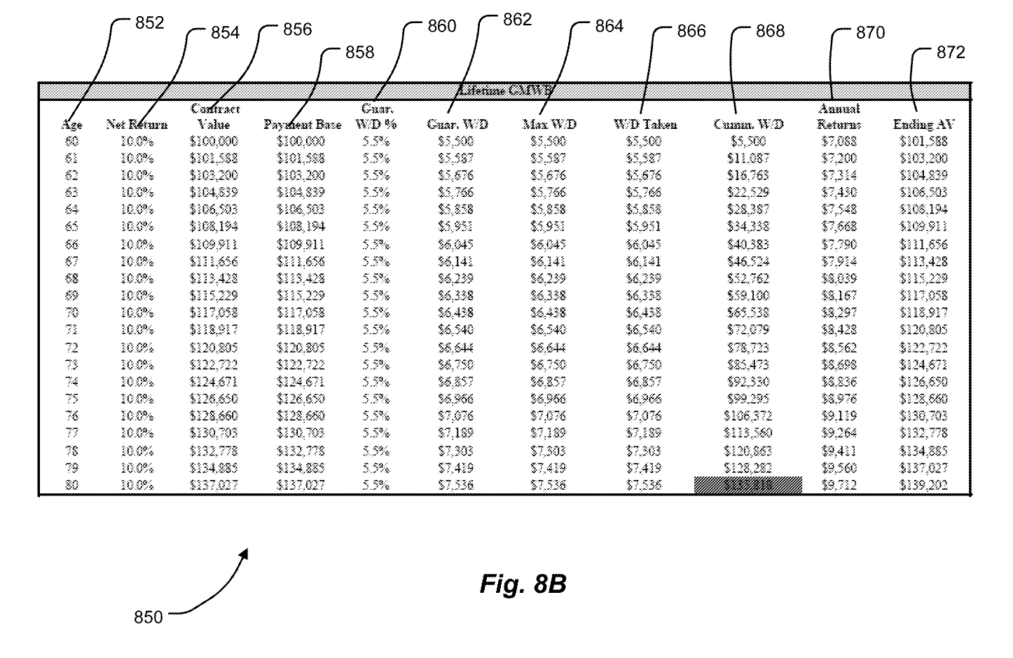

In an embodiment illustrated in FIGS. 8A and 8B, a method and system will be illustrated in which an annuity in which a guaranteed minimum withdrawal benefit has a payment advantage related to an agreement by an annuitant to receive payments in a first payment mode, which in this embodiment is a debit card account. In FIG. 8A, a chart 800 shows exemplary values in an example of an insurance account, and in particular an annuity, starting with the annuitant's age of 60 and a contract value of $100,000, with a guaranteed minimum withdrawal benefit of 5.0% of a payment base equal to the net asset value. In this example, the annual return is 10%, and the fees are 2.5%. The annuity may be a variable annuity, for example. In the example of chart 800, a first payment mode, such as a check payable to the annuitant, is provided. In column 802, the age of the annuitant for each year of the example is shown. In column 804, the account value, or net asset value, at the beginning of each year is shown. The net asset value is incremented by the annual returns of column 820, less the withdrawal taken of column 816, to obtain the ending asset value for each year of column 822. The ending asset value in column 822 becomes the beginning asset value of column 804 for the following year. Column 808 shows the payment base for calculation of the guaranteed minimum withdrawal benefit. In this example, the payment base is 100% of the contract value throughout the period of the example. The guaranteed withdrawal percentage is shown at column 810, and is determined by contract to be 5.0% of the payment base throughout the period shown. The guaranteed withdrawal amount is shown in column 812. The maximum withdrawal amount is shown in column 814. In this example, the maximum withdrawal amount is the same as the guaranteed minimum withdrawal amount. The maximum withdrawal amount may be the greater of the minimum withdrawal amount and an amount calculated based on a formula; in this case, the minimum withdrawal amount is always greater than the calculated amount from the formula. For purposes of this illustration, the annuitant takes the entire maximum withdrawal amount each year, as indicated in column 816. Column 818 is a sum of the withdrawals taken in the illustration. Column 820, as noted above, is the annual return amount, which is the product of (1) the starting asset value, less the withdrawal amount, by (2) the annual returns less the fees. By way of example, in the first year, the annual return is $95,000 multiplied by 7.5%.

Referring to FIG. 8B, chart 850 shows exemplary values in an example of an insurance account, and in particular an annuity, similar to that shown in FIG. 8A, except that a second payment mode has been selected, such as payment to an account accessed via a debit card. Under applicable contractual provisions, as a result of the annuitant's agreement to accept payment to the debit card account, the guaranteed minimum withdrawal benefit is increased. In this example, the guaranteed minimum withdrawal benefit is 5.5% of the payment base, rather than 5.0% had a different payment mode been employed. The example of FIG. 8B shows an annuity with the annuitant's age at 60 and a contract value of $100,000, with a guaranteed minimum withdrawal benefit of 5.5% of the account asset value. In this example, the annual return is 10%, and the fees are 2.5%. Column 852 indicates the annuitant's age in any particular year in the 20 years indicated in the illustration. Column 854 indicates an annual net return, which is always 10.0% in this example. Column 856 indicates the contract value, or net asset value, prior to the withdrawal at the beginning of each year. Column 858 represents the payment base for calculation of the guaranteed minimum withdrawal amount, which is the same as the contract value at the beginning of the year. Column 860 shows the guaranteed minimum withdrawal percentage, which is at 5.5% for all years in the example. The guaranteed withdrawal amount is shown in column 862. The guaranteed withdrawal amount is higher in this example than in chart 800 of FIG. 8A for the first 19 years. As a result of the effect of the greater withdrawals on the asset value and hence the payment base, the guaranteed withdrawal amount in this example than in the example of FIG. 8B in the 20^{th} year of the contract.

The maximum withdrawal amount is shown in column 864, and is the same as the guaranteed minimum withdrawal amount in each year. The actual withdrawal taken is shown in column 866, and is equal to the maximum withdrawal amount. The cumulative withdrawal amount is shown in column 868. The annual return is shown in column 870, and is equal to 7.5% of the asset value at the beginning of the year, less the withdrawal taken. As the withdrawal taken is greater in this example than in the example of FIG. 8A, and consequently the asset value grows less quickly, the annual return is less than in the example of FIG. 8B. The ending asset value is shown at column 872. The asset value at the end of each year is shown in column 874, and is lower than the corresponding asset value in the embodiment of FIG. 8A.

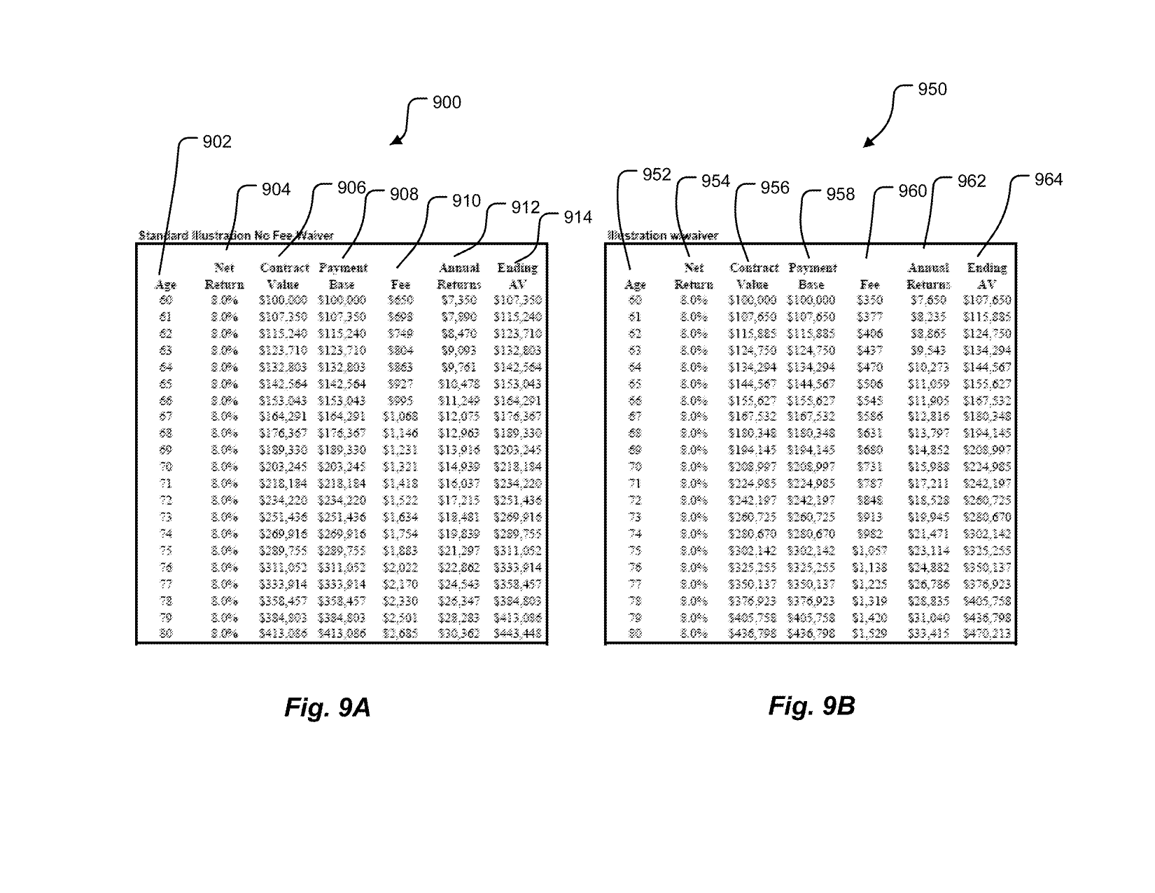

Referring now to FIGS. 9A and 9B, exemplary embodiments are illustrated in which, an annuity has been funded in a first mode, as in FIG. 9A, a first rider charge is applicable to an insurance account, and, if an annuity is funded in a second mode, such as by a payment from a liquid account designated by the insurance company, as in FIG. 9B, a second, lower rider charge is applicable. In FIG. 9A, a chart 900 shows exemplary values in an example of an insurance account, and in particular an annuity, starting with the annuitant's age of 60 and a contract value of $100,000, with a guaranteed minimum withdrawal benefit rider. In this example, the annuitant does not take any withdrawals. The annual return is 8%. As the premium has not been paid from a preferred account, such as a liquid account sponsored by the insurance company, the fees are 65 basis points of the contract value per year (bps). The annuity may be a variable annuity, for example. In the example of chart 900, a first funding source, such as funding from a checking account of the annuitant at a bank not connected with the insurance company, is provided. Column 902 shows an age of the annuitant in each year. Column 904 shows a net annual return, which in this example is 8.0% for each of the 21 years shown. The contract value is shown at 906; the initial value is $100,000, which may be an initial premium payment. A payment base for a guaranteed minimum withdrawal benefit is shown at 908. In this example, the payment base is equal to 100% of the contract value at the beginning of the year. The fee 910 is calculated from 65 bps, using the contract value. In an embodiment, a system may include a processor that accesses in memory data indicative of a received payment mode, and, if the data indicative of the received payment mode indicates a standard payment mode, then the processor accesses a standard rider fee amount from memory, and employs the standard rider fee amount in an algorithm to calculate the rider fee amount. The annual returns in column 910 are based on the net return of column 904, less the fee of column 910. The ending asset value 914 is the sum of the contract value 906, plus the annual returns 912. If there are withdrawals, the ending asset value would be reduced by the amount of the withdrawals.

In the example shown in FIG. 9B, an annuitant has paid an initial premium from a liquid account, as discussed above. The contract between the annuitant and the insurance company provides for a reduction in the guaranteed minimum withdrawal rider amount; in the example of chart 950, the guaranteed minimum withdrawal rider has a cost of 35 basis points of the contract value per year. Column 952 shows an age of the annuitant in each year. Column 954 shows a net annual return, which in this example is 8.0% for each of the 21 years shown. The contract value is shown at 956; the initial value is $100,000, which may be an initial premium payment made from the liquid account, for example. A payment base for a guaranteed minimum withdrawal benefit is shown at 958. In this example, the payment base is equal to 100% of the contract value at the beginning of the year. The fee 960 is calculated from 35 bps, using the contract value. In an embodiment, a system may include a processor that accesses in memory data indicative of a received payment mode, and, if the data indicative of the received payment mode indicates a preferred payment mode, then the processor accesses a lower rider fee amount from memory, and employs the lower rider fee amount in an algorithm to calculate the rider fee amount. The annual returns in column 962 are based on the net return of column 954, less the fee of column 960. The ending asset value 964 is the sum of the contract value 966, plus the annual returns 962. If there are withdrawals, the ending asset value would be reduced by the amount of the withdrawals. The reduction in the fee results in an ending asset value of $470,213 in chart 950, compared to $443,448 in chart 900.

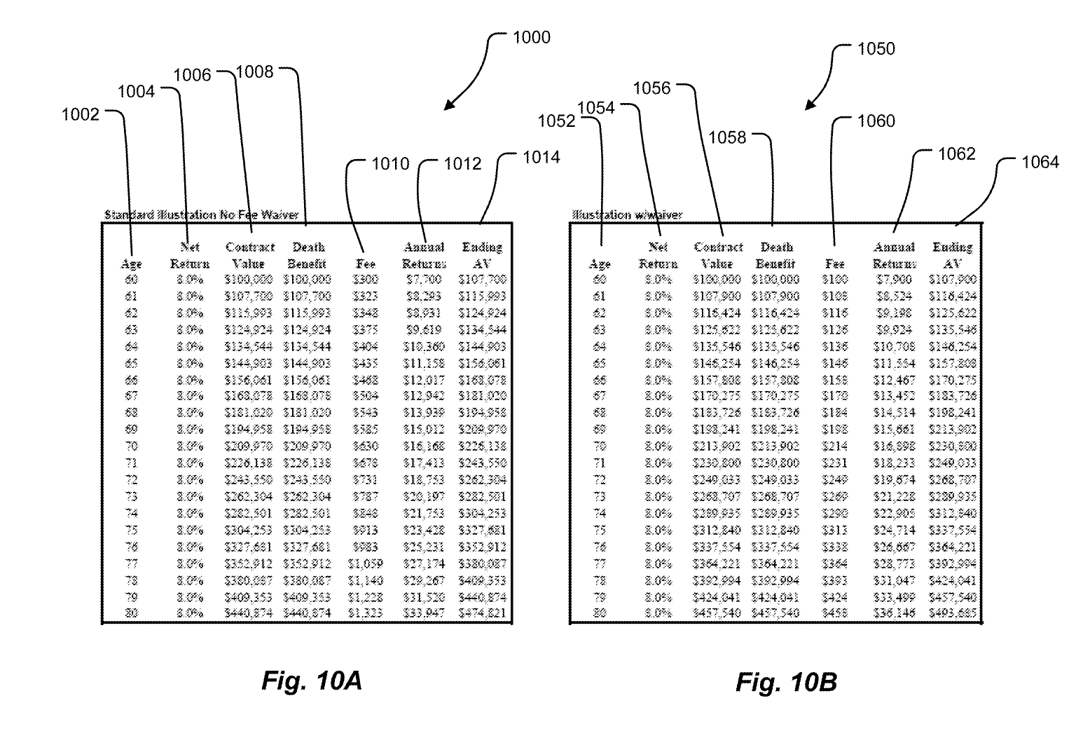

Referring now to FIGS. 10A and 10B, further exemplary embodiments are illustrated in which, an annuity has been funded in a first mode, as in FIG. 1A, a first rider charge is applicable to an insurance account, and, if an annuity is funded in a second mode, such as by a payment from a liquid account designated by the insurance company, as in FIG. 10B, a second, lower rider charge is applicable. In FIG. 10A, a chart 1000 shows exemplary values in an example of an insurance account, and in particular an annuity, starting with the annuitant's age of 60 and a contract value of $100,000, with a maximum anniversary value (MAV) rider. The term maximum anniversary value is known in the field of insurance annuities, and particularly variable annuities, and means generally that the death benefit of an insurance policy in the form of an annuity is equal to the highest contract value on any prior anniversary of the policy. In the absence of a MAV rider, the death benefit may be equal to the contract value on the most recent anniversary of the policy. In this example, the annuitant does not take any withdrawals. The annual return is 8%. As the premium has not been paid from a preferred account, such as a liquid account sponsored by the insurance company, the fees are 30 basis points of the contract value per year (bps). The annuity may be a variable annuity, for example. In the example of chart 1000, a first payment mode, such as a check payable to the annuitant, is provided. Column 1002 shows an age of the annuitant in each year. Column 1004 shows a net annual return, which in this example is 8.0% for each of the 21 years shown. The contract value is shown at 1006; the initial value is $100,000, which may be an initial premium payment. A death benefit is shown at 1008. In this example, the death benefit is based on the greatest contract value on an anniversary of the policy, from column 1006. As the annual return is always greater than the fees in this example, the death benefit is always equal to the contract value on the most recent anniversary. In an implementation where the contract value decreases during an annual period, such as occurs during certain periods in a variable annuity in which the value is based on a stock index, the death benefit is equal to a contract value on an earlier anniversary for certain years. The fee 1010 is calculated from 30 bps, using the contract value. In an embodiment, a system may include a processor that accesses in memory data indicative of a received payment mode, and, if the data indicative of the received payment mode indicates a standard payment mode, then the processor accesses a standard rider fee amount from memory, and employs the standard rider fee amount in an algorithm to calculate the rider fee amount. The annual returns in column 1010 are based on the net return of column 1004, less the fee of column 1010. The ending asset value 1014 is the sum of the contract value 1006, plus the annual returns 1012. If there are withdrawals, the ending asset value would be reduced by the amount of the withdrawals.

In the example shown in FIG. 10B, an annuitant has paid an initial premium from a liquid account, as discussed above. The contract between the annuitant and the insurance company provides for a reduction in the fee for the MAV rider; in the example of chart 1050, the MAV rider has a fee of 10 basis points of the contract value per year. Column 1052 shows an age of the annuitant in each year. Column 1054 shows a net annual return, which in this example is 8.0% for each of the 21 years shown. The contract value is shown at 1056; the initial value is $100,000, which may be an initial premium payment made from the liquid account, for example. A death benefit is shown at 1008. In this example, the death benefit is based on the greatest contract value on an anniversary of the policy, from column 1006. As the annual return is always greater than the fees in this example, the death benefit in this example is always equal to the contract value on the most recent anniversary. The MAV rider fee 1060 is calculated at 10 bps, using the contract value. In an embodiment, a system may include a processor that accesses in memory data indicative of a received payment mode, and, if the data indicative of the received payment mode indicates a preferred payment mode, then the processor accesses a lower rider fee amount from memory, and employs the lower rider fee amount in an algorithm to calculate the rider fee amount. The annual returns in column 1062 are based on the net return of column 1054, less the MAV rider fee of column 1060. The ending asset value 1064 is the sum of the contract value 1066, plus the annual returns 1062. In this example, there are no withdrawals or other payments to the annuitant. If there are withdrawals, the ending asset value would be reduced by the amount of the withdrawals. The reduction in the MAV rider fee results in an ending asset value of $493,685 in chart 1050, compared to $474,821 in chart 1000.

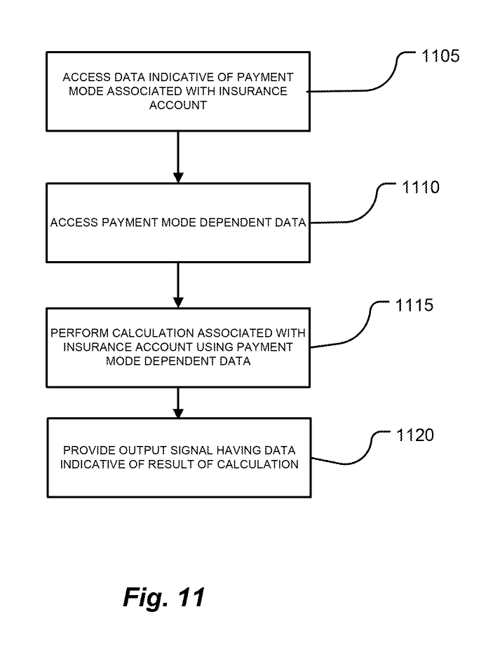

Referring to FIG. 11, an exemplary embodiment of a method for administration of an insurance account will be discussed. This method may be implemented, by way of example, by processor 110 of FIG. 1 accessing data from local memory 120 and/or memory storage 130. Referring again to FIG. 11, a processor accesses 1105 from a memory in communication with the processor data indicative of a payment mode associated with premium payments to the account or payments from the account. The processor accesses 1110 from the memory data indicative of a calculation associated with the account dependent on the payment mode. The processor performs 1115 the calculation based on the accessed payment mode dependent data. The processor provides 1120 an output signal comprising data indicative of a result of the performed calculation.

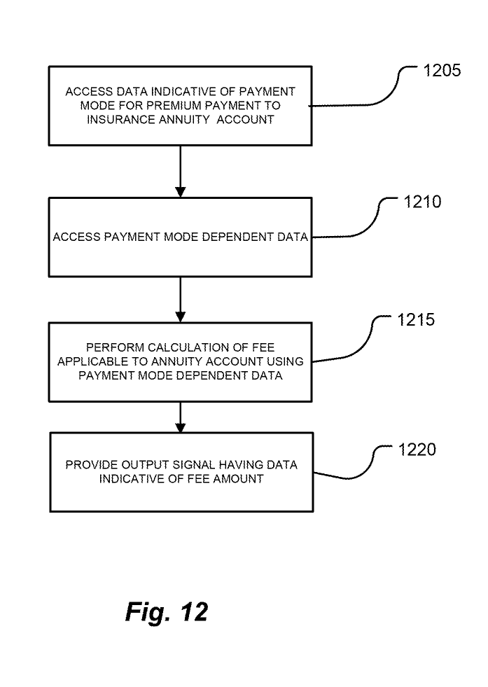

Referring now to FIG. 12, a method of administering an insurance account having rider fees dependent on payment mode data in accordance with an embodiment of the invention is illustrated. The method of FIG. 12 may be an implementation of the method of FIG. 11. Referring again to FIG. 12, a processor accesses 1205 from the memory data indicative of a payment mode for premium payments to an insurance account. The processor accesses 1210 from the memory payment mode dependent data, such as a factor in a formula for calculating a rider fee. The processor 1215 performs a calculation of a fee, such as a rider fee, related to the payment mode dependent data. The processor 1220 provides an output signal having data including a result of the calculation, such as the amount of the rider fee.

In an implementation of a method, such as the method of FIG. 11, a method for administering a variable annuity account with an insurance entity, such as an insurance company or other legal entity providing insurance, may include accessing, by a processor, from a memory storage device data relating to the variable annuity account; accessing from the memory storage device data indicative of a payment mode associated with premium payments to or withdrawal payments from the variable annuity account; accessing from the memory storage device data indicative of a factor in a formula associated with the account, a value of the factor being dependent on the payment mode; perform, based at least in part on the accessed factor value, one or more calculations associated with the insurance account; and provide an output signal comprising data indicative of a result of the one or more calculations.

In one example, the payment mode is associated with premium payments to the variable annuity account. The payment mode may be one of at least a first payment mode being payments from a money market account maintained by the insurance entity or a second payment mode being payments from sources other than the money market account. The factor is a rider fee rate. The value of the factor is a first value if the payment mode is the first payment mode and a second value, the second value being greater than the first value, if the payment mode is the second payment mode. The one or more calculations may include a calculation of the amount of the rider fee based on the value of the factor. Exemplary factors are discussed above in connection with the illustrates of FIGS. 9A, 9B, 10A and 10B.

In a further embodiment, the payment mode is associated with payments from the variable annuity account. The payment mode may be at least one of a first payment mode being one of payments to a liquid account maintained by the insurance entity, payments crediting a debit card and payments in the form of a gift card. The second payment mode may be payments in the form of a check or an electronic transfer to an account not associated with the insurance entity. The factor is a payment augmentation rate; the value of the factor is a first value if the payment mode is the first payment mode and a second value, the second value being less than the first value, if the payment mode is the second payment mode. For example, a payment amount may be calculated without reference to the payment mode, and then multiplied by a factor. If the payment mode is the first payment mode, the factor may be greater than 1, such as 1.05. If the payment mode is the second payment mode, the factor may be equal to 1. The one or more calculations include a calculation of the amount of a payment to an annuitant from the variable annuity account.

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by processor 110 executing instructions contained in programs which may be stored in a storage medium, such as local memory 120 or data storage 130. It will be appreciated that any of the steps in the methods in accordance with the invention described herein may be so implemented.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administering a variable annuity account with an insurance entity, comprising:
a processor;
a memory storage device in communication with the processor;
the processor adapted to:
access from a memory storage device data relating to the variable annuity account;
access from the memory storage device data indicative of a payment mode associated with premium payments to or withdrawal payments from the variable annuity account;
access from the memory storage device data indicative of a factor in a formula associated with the account, a value of the factor being dependent on the payment mode;
perform, based at least in part on the accessed factor data, one or more calculations associated with the insurance account; and
provide an output signal comprising data indicative of a result of the one or more calculations.

2. The system of claim 1, wherein: the payment mode is associated with premium payments to the variable annuity account; the payment mode may be one of at least a first payment mode being payments from a money market account maintained by the insurance entity or a second payment mode being payments from sources other than the money market account; the factor is a rate of a rider fee; the value of the factor is a first value if the payment mode is the first payment mode and a second value, the second value being greater than the first value, if the payment mode is the second payment mode; and the one or more calculations comprises a calculation of the amount of the rider fee based on the value of the factor.

3. The system of claim 1, wherein: the payment mode is associated with payments from the variable annuity account; the payment mode may be at least one of a first payment mode being one of payments to a liquid account maintained by the insurance entity, payments crediting a debit card and payments in the form of a gift card, and a second payment mode being payments in the form of a check or an electronic transfer to an account not associated by the insurance entity; the factor is a payment augmentation rate; the value of the factor is a first value if the payment mode is the first payment mode and a second value, the second value being less than the first value, if the payment mode is the second payment mode; and the one or more calculations comprises a calculation of the amount of a payment to an annuitant from the variable annuity account.

4. A computer system for administering an insurance account, comprising:
a processor;
a memory in communication with the processor;
the processor adapted to:
access from the memory data indicative of a payment mode associated with premium payments to the account or payments from the account;
access from the memory data indicative of a calculation associated with the account dependent on the payment mode;
perform the calculation based on the accessed payment mode dependent data; and
provide an output signal comprising data indicative of a result of the performed calculation.

5. The system of claim 4, wherein the payment mode relates to payments from the account, and the payment mode dependent data comprises payment augmentation data.

6. The system of claim 5, wherein the payment mode comprises crediting to a debit card.

7. The system of claim 5, wherein the payment mode comprises providing a gift card to a payee.

8. The system of claim 7, wherein the gift card may be redeemed for purchases at one and only one retailer.

9. The system of claim 5, wherein the payment mode comprises crediting an account administered by a payor that administers the insurance account.

10. The system of claim 9, wherein the credited account is a liquid account.

11. The system of claim 10, further comprising a web server, the web server adapted to, in response to a request from a client device, access and serve for display on the client device data related to the insurance account and, in response to a request from a client device, to access and serve for display on the client device data related to the liquid account.

12. The system of claim 10, wherein the liquid account is a money market account.

13. The system of claim 4, wherein the insurance account is an annuity.

14. The system of claim 13, wherein the insurance account is a single premium immediate annuity.

15. The system of claim 4, wherein the payment mode comprises crediting a money market account administered by a provider of the insurance account.

16. The system of claim 15, further comprising a web server, wherein, in response to a signal having data indicative of a user request, a signal is output by the web server and received at a processor, whereby funds are transferred from the money market account in accordance with the user request.

17. The system of claim 5, wherein the processor is further adapted to access data indicative of a first payment mode associated with a first portion of a payment from the insurance account, and a second payment mode associated with a second portion of the payment, and determine an amount of an augmented payment based on the first portion of the payment and the payment augmentation data.

18. The system of claim 5, wherein the output signal comprises data indicative of the payment mode, and further comprising:
a payment determination system having a processor for: receiving the output signal, determining a payor account and a payment method; storing the determined payor account information and the determined payment method in a memory of the payment determination system; outputting of a digital signal indicative of the stored payor account information, the stored payment method, amount information and payee information; and
a payment fulfillment system for receiving the digital signal from the payment determination system and for fulfillment of payment in accordance with the information conveyed by the digital signal from the processor of the payment determination system.

19. The system of claim 18, wherein the payment fulfillment system is a check printing and mailing system for printing and mailing a check drawn on the payor account in an amount and to a payee as determined by the information conveyed by the digital signal from the processor of the payment determination system.

20. The system of claim 18, wherein the payment fulfillment system is a system for generating electronic funds transfer instructions for providing of an instruction to a bank determined by the payor account information to provide an electronic funds transfer from the payor account to a payee account in an amount determined by the information conveyed by the digital signal from the processor of the payment determination system.

21. The system of claim 4, wherein: the payment mode is associated with premium payments to the insurance account; the payment mode may be one of at least a first payment mode being payments from a designated liquid account or a second payment mode being payments from sources other than the liquid account; and the calculation is a calculation of a fee, the fee being calculated at a first rate if the payment mode is the first payment mode and at a second rate, the second rate being greater than the first rate.

22. The system of claim 21, wherein the insurance account is an annuity, and the fee is a rider fee.

23. A computer-implemented method for administering an insurance account, comprising the steps of:
accessing by a processor from a memory storage device in communication with the processor data indicative of a payment mode associated with premium payments to the account or payments from the account;
accessing by the processor from the memory storage device data indicative of a calculation associated with the account dependent on the payment mode;
performing by the processor the calculation based on the accessed payment mode dependent data; and
providing by the processor an output signal comprising data indicative of a result of the performed calculation.

24. The method of claim 23, wherein the payment mode relates to payments from the account, and the payment mode dependent data comprises payment augmentation data.

25. The method of claim 24, wherein the output signal further comprises data indicative of the payment mode.

26. The method of claim 23, wherein the payment mode is associated with premium payments to the insurance account; the payment mode may be one of at least a first payment mode being payments from a designated liquid account or a second payment mode being payments from sources other than the liquid account; and the calculation is a calculation of a fee, the fee being calculated at a first rate if the payment mode is the first payment mode and at a second rate, the second rate being greater than the first rate.

27. A computer-readable medium having a plurality of instructions thereon which, when executed by a processor, cause the processor to:
access from a memory storage device in communication with the processor data indicative of a payment mode associated with one or more premium payments to an insurance annuity account or one or more annuity or death benefit payments from the account;
if the payment mode is associated with the one or more premium payments, access from the memory storage device data indicative of a calculation of at least one of a rider fee or a mortality and expense charge associated with the annuity account dependent on the payment mode, wherein a first premium payment mode pertains to premium payments from a designated account, and a second premium payment mode pertains to premium payments from all other sources, wherein the rider fee or mortality and expense charge is lower for the first premium payment mode than the second premium payment mode;
if the payment mode is associated with one or more annuity or death benefit payments, access from the memory storage device data indicative of a calculation of the amount of the annuity or death benefit payment dependent on the payment mode, wherein a first outbound payment mode is to a debit card, gift card or insurance provider-designated account, and a second outbound payment mode is by check or electronic transfer to an account other than the designated account, a payment amount being larger if associated with the first outbound payment mode than the second outbound payment mode;
perform the calculation based on the accessed payment mode dependent data;
provide an output signal comprising data indicative of a result of the performed calculation.

28. The computer-readable medium of claim 27, wherein the instructions further cause the processor to access from the memory demographic information relating to an annuitant or a beneficiary; based on the accessed demographic information, to prompt a user to provide a selection of payment mode; to receive a selection of a payment mode; and to perform the calculation based on the received payment mode.

29. The computer-readable medium of claim 27, wherein the instructions further cause the processor to prompt a user for the demographic information, and to store the received demographic information in the memory.

30. The computer-readable medium of claim 29, wherein the demographic information includes age and address of the beneficiary or annuitant.

31. The computer-readable medium of claim 30, wherein the instructions further cause the processor to prompt a user for a selection of a payment mode applying a payment to a premium payment for a presented property/casualty insurance product, the property/casualty insurance product being presented based on the demographic information.
